(19) United States
(12) Patent Application Publication
(10) Pub. No.: US 2005/0146663 A1
(43) Pub. Date: Jul. 7, 2005

(54) Vertically aligned mode liquid crystal display

(76) Inventors: Jin-Yun Kim, Seoul (KR); Seung-Hee Lee, Choongcheonbuk-do (KR)

Correspondence Address: F. CHAU & ASSOCIATES, LLC, 130 WOODBURY ROAD, WOODBURY, NY, 11797, US

(21) Appl. No.: 10/505,643

(22) PCT Filed: Jun. 12, 2002
(86) PCT No.: PCT/KR02/01107

(30) Foreign Application Priority Data
Mar. 29, 2002 (KR) 2002/17355

(51) Int. Cl. G02F 1/1337

(52) U.S. Cl. 349/130

(57) ABSTRACT

A liquid crystal display is provided, which includes a first insulating substrate; a pixel electrode formed on the first substrate and having a first aperture pattern; a thin film transistor formed on the first substrate and switching voltages applied to the pixel electrode; a second insulating substrate opposite to the first substrate; a reference electrode formed on the second substrate and having a second aperture pattern to partition the pixel electrode into a plurality of subareas together with the first aperture pattern; and a liquid crystal layer interposed between the first substrate and the second substrate and having the thickness ranging 3.4-4.0 μm. The above described adjustment of the cell gap and the applied electric field can keep the response time of an LCD to be equal to or lower than a predetermined value.

### BACKGROUND OF THE INVENTION

(a) Field of the Invention

The present invention relates to a liquid crystal display, and in particular to a vertically aligned liquid crystal display to implement a wide viewing angle by dividing a pixel region into a plurality of small domains using domain dividing means.

(b) Description of the Related Art

Generally, a liquid crystal display (“LCD”), which includes an upper panel with a common electrode and color filters, a lower panel with thin film transistors (“TFTs”) and pixel electrodes, and a liquid crystal layer disposed therebetween, is a display device that displays images by applying different electric potentials to the pixel electrodes and the common electrode to generate electric field to change the arrangement of liquid crystal molecules, thereby controlling the transmittance of light.

Meanwhile, an LCD has a major disadvantage of narrow viewing angle. To overcome the disadvantage, several methods for increasing the viewing angle have been developed. Among them, a method is promising, which aligns liquid crystal molecules vertically with respect to upper and lower panels and provides aperture patterns or protuberances on pixel electrodes and a common electrode opposite thereto.

The method of forming aperture patterns is to form aperture patterns both on the pixel electrodes and the common electrode and to adjust tilt directions of the liquid crystal molecules using fringe field generated due to the aperture patterns hereinafter, referred to as “PVA (patterned vertically aligned) mode”).

Meanwhile, an LCD has a disadvantage of slow response compared with CRT because it tales time to change the arrangement of the liquid crystal molecule when applied with driving voltages. When the response speed is lower than a given value, the high image quality in displaying moving pictures cannot be not obtained since after-images are recognized. Consequently, methods for increasing the response speed as much as possible have to be studied.

### SUMMARY OF THE INVENTION

An object of the present invention is to improve the response speed of the vertically aligned mode LCD.

To accomplish the object, the present invention keeps the cell gap of the vertically aligned mode LCD in a predetermined range.

In detail, a liquid crystal display is provided, which includes a first insulating substrate; a pixel electrode formed on the first substrate and having a first aperture pattern; a thin film transistor formed on the first substrate and switching voltages applied to the pixel electrode; a second insulating substrate opposite to the first substrate; a reference electrode formed on the second substrate and having a second aperture pattern to partition the pixel electrode into a plurality of subareas together with the first aperture pattern; and a liquid crystal layer interposed between the first substrate and the second substrate and having the thickness ranging 3.4-4.0 μm.

It is preferable that liquid crystal molecules contained in the liquid crystal layer are aligned substantially perpendicular to the first substrate and the second substrate in absence of electric field, and the strength of electric field applied to liquid crystal molecules contained in the liquid crystal layer is in a range of 1.17 V/μm-1.33 V/μm.

### BRIEF DESCRIPTION OF THE DRAWINGS

FIG. 1 is a sectional view of an LCD according to an embodiment of the present invention;

FIG. 2 is a graph illustrating the on and off response times as function of the cell gap in an LCD according to an embodiment of the present invention;

FIG. 3 is a graph showing the minimum response time as functions of the cell gap in an LCD according to an embodiment of the present invention;

FIG. 4 is a graph of the response time as function of white gray voltages for various cell gaps in an LCD according to an embodiment of the present invention;

FIG. 5 is a graph showing voltages giving the minimum response time as function of cell gap in an LCD according to an embodiment of the present invention; and

FIG. 6 is a graph showing electric fields giving the minimum response time as function of an LCD according to an embodiment of the present invention.

| | | | |
|---|---|---|---|
| 110: | TFT array panel | 3: | liquid crystal layer |
| 123: | gate electrode | 140: | gate insulating layer |
| 151: | polysilicon layer | 171: | data line |
| 173: | source electrode | 175: | drain electrode |
| 180: | passivation layer | 190: | pixel electrode |
| 210: | color filter panel | 230: | color filter |
| 220: | black matrix | 250: | overcoat |
| 270: | reference electrode | 191 and 271: | aperture |

### DETAILED DESCRIPTION OF PREFERRED EMBODIMENTS

Now, an LCD according to an embodiment of the present invention will be described with reference to the drawings.

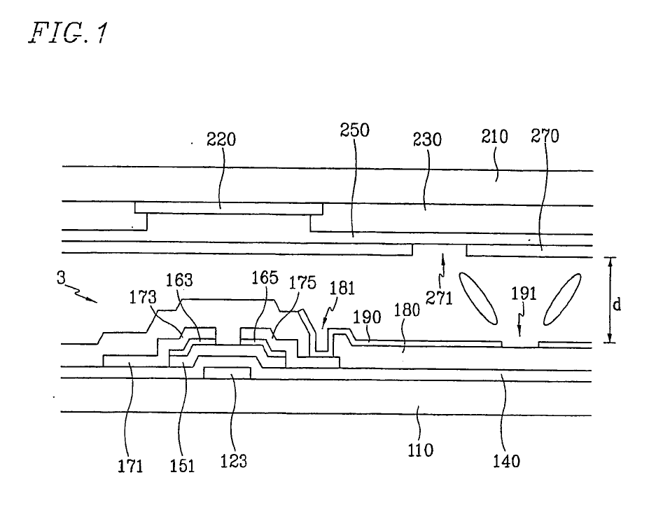

FIG. 1 is a sectional view of an LCD according to an embodiment of the present invention.

First, a TFT array panel will be described.

A gate wire is formed on an insulating substrate 110. The gate wire includes a gate line (not shown) extending in a transverse direction, a gate pad (not shown) connected to one end of the gate line to receive gate signals from an external device and to transmit them to the gate line and a gate electrodes 123 of a TFT, which is a portion of the gate line.

The gate wire may be formed of a single layer, double layers or triple layers. The single layer is preferably made of Al or Al—Nd alloy, and the double layers preferably include a lower layer made of material having good physical-chemical characteristics such as Cr, Mo or Mo alloy and an upper layer made of material having low resistivity such as Al or Al alloy.

A gate insulating layer preferably made of SiNx is formed on the gate wire.

A semiconductor layer 151 made of semiconductor such as hydrogenated amorphous silicon is formed on the gate insulating layer. The semiconductor layer 151 overlaps the gate electrode 123.

A contact layer 163 and 165 made of material such as n+ hydrogenated amorphous silicon heavily doped with n-type impurity is formed on the semiconductor layer 151. The contact layer 163 and 165 is divided into two portions opposite each other with respect to the gate electrode 123.

A data wire is formed on the contact layer 163 and 165. The data wire includes a source electrode 173 formed on a source portion 163 of the contact layer, a data line 171 connected to the source electrode 173 and extending in a longitudinal direction, a data pad (not shown) connected to one end of the data line 171 and applied with image signals from an external device, and a drain electrode 175 formed on a drain portion 165 of the contact layer opposite the source electrode 173 with respect to the gate electrode 123.

The data wire may have a single-layered structure, a double-layered structure or a triple-layered structure like the gate wire. The single-layered structure is preferably made of Al or Al—Nd alloy, and the double-layered structure preferably include a lower layer made of material having good physical-chemical characteristics such as Cr, Mo or Mo alloy and an upper layer made of material having low resistivity such as Al or Al alloy.

A passivation layer 180 is formed on the data wire. The passivation layer 180 covers and protects a channel portion between the source electrode 173 and the drain electrode 175, and, in this embodiment, it covers all the data wire as well as the channel portion, except for the contact hole 181 exposing the drain electrode 175 and a contact hole (not shown) exposing the data pad.

A pixel electrode 190 made of a transparent conducting material such as ITO (indium tin oxide) or IZO (indium zinc oxide) is formed on the passivation layer 180, and a plurality of auxiliary pads (not shown) made of the same material as the pixel electrode 190 are formed on the gate pad, a storage electrode pad and the data pad. In a reflective type LCD, the pixel electrode 190 is made of metal reflecting light well such as Al.

The pixel electrode 190 has an aperture pattern 191.

Next, a color filter panel will be described.

A black matrix made of one of a single chromium layer, double layers of chromium and chromium oxide, and organic material containing black pigments is formed on a transparent insulating substrate 210. A plurality of red, green and blue color filters are formed on the black matrix. The red, green and blue color filters 230 are assigned in each pixel area partitioned by the black matrix 220. An overcoat 250 made of organic insulating material is formed on the color filters 230, and a reference electrode 270 made of transparent conductive material is formed on the overcoat. An aperture pattern 271 is provided in the reference electrode 270. The function of the overcoat 250 is to prevent the color filters from being exposed through the aperture pattern.

The LCD according to the first embodiment is obtained by aligning and combining the TFT array panel and the color filter panel and then injecting liquid crystal material 3 therebetween. The liquid crystal molecules contained in the liquid crystal material are aligned such that their director is perpendicular to the substrates 110 and 210 in absence of electric field between the pixel electrode 190 and the reference electrode 270. The TFT array panel and the color filter panel are aligned so that the pixel electrode 190 exactly corresponds to the color filter 230. In this way, a pixel region is divided into a plurality of small domains by the aperture patterns 191 and 271. The classifications of the small domains are determined based on the tilt directions of the director of the liquid crystal molecules.

In this LCD, the cell gap d, which is defined as the thickness of the liquid crystal layer, keeps in a range of 3.4-4.0 μm. This enables the response time to be generally equal to or lower than 25 ms, which is a standard response time of LCD products displaying moving pictures.

For the strength of the electric field in a range 1.17-1.33 V/microns, the response time can be equal to or lower than 25 ms, which is a standard response time of LCD products displaying moving pictures.

Now, the reason for the above determined ranges of the cell gap d and the electric field as above will be examined.

Generally, the response time of an LCD is known as proportional to the square of the cell gap, and a TN (twisted nematic) mode LCD and a CE (coplanar electrode) mode LCD conform to this rule. However, a PVA mode LCD often does not conform to this rule. Accordingly, a response time as function of a cell gap is required to be measured in order to find the cell gap providing the fastest response speed.

Table 1 illustrates a measured response time as function of cell gap in a PVA mode LCD according to an embodiment of the present invention. The unit of the response time is milliseconds.

TABLE 1

| Cell gap [μm] | 2.850 | 3.155 | 3.576 | 3.695 | 3.923 | 3.936 | 4.132 |
|---|---|---|---|---|---|---|---|
| ON [ms] | 40.21 | 26.59 | 16.63 | 15.32 | 16.32 | 14.05 | 13.76 |
| OFF [ms] | 4.75 | 5.23 | 6.95 | 7.35 | 8.00 | 10.36 | 11.98 |
| ON + OFF [ms] | 44.96 | 31.82 | 23.58 | 22.68 | 24.33 | 24.11 | 25.75 |

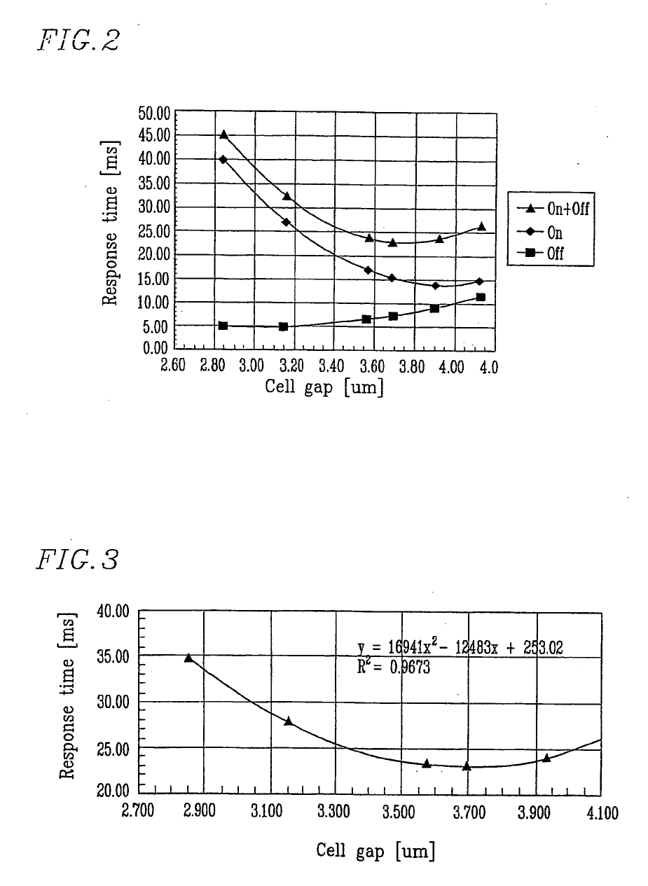

FIG. 2 shows curves corresponding to Table 1.

As shown in FIG. 2, it can be seen that, in the PVA mode, when the cell gap is lower than about 3.66 μm, the on response tine ON rapidly increases as the cell gap becomes smaller. When the cell gap is larger than about 3.66 μm, the on response time ON also increases as the cell gap becomes smaller, even though the increasing gradient is vary smooth. In contrast, the off response time OFF increases nearly in proportion to the square of the cell gap. The curve ON+OFF represents the sum of the on response time ON and the off response time OFF. The curve ON+OFF for the cell gap lower than 3.66 μm varies mainly dependent on the on response time ON, while the curve ON+OFF for the cell gap larger than 3.66 μm varies mainly depending on the off response time OFF. Thus, the sum ON+OFF of the on response tine ON and the off response time OFF exhibits the minimum at about 3.66 μm and tends to increase as the cell gap increases or decreases with respect to 3.66 μm.

FIG. 3 is a graph showing minimum response time as function of cell gap in an LCD according to an embodiment of the present invention.

As shown in FIG. 3, the response time for the cell gap of about 3.66 μm is about 21.37 μm. In addition, it can seen that the range of the cell gap, which meets the standard response time equal to or lower than 25 ms of LCD products, is 3.40-4.00 μm.

Next, the strength of electric field will be examined.

Since the behaviors of liquid crystal molecules become faster for increasing strength of electric field, the response time is mistakenly considered to become shorter, but it is not true in the actual world. This is because the over-strong electric field strengthens bad, flow of texture from the data wire to more than a given extent to delay the behaviors of the liquid crystal molecules, thereby making the response time for displaying desired images to become rather larger. The texture is referred to a phenomenon that some liquid crystal molecules near the apertures of the pixel electrode exhibit abnormal behaviors to tilt in unexpected directions due to distortion of the electric filed near the apertures of the pixel electrode. The back flow is referred to a phenomenon that such a texture moves in a direction opposite the expected direction in which the liquid crystal molecules are expected to move, due to a strong initial electric field. The region with the back flow occupies only a portion of the entire pixel region, and the flow returns to the expected direction within a few seconds. Accordingly, it is required to find out the strength of the electric field, which minimizes the back flow.

Table 2 is a graph showing the response time versus white gray voltage for various cell gaps in an LCD according to an embodiment of the present invention.

TABLE 2

| Cell gap | Response time per white voltages | | | | | | |
|---|---|---|---|---|---|---|---|
| 2.85 μm | Voltages | 2.64 | 2.80 | 3.08 | 3.40 | 3.96 | 5.04 |
| | ON | 41.97 | 34.90 | 31.90 | 30.25 | 32.76 | 40.21 |
| | OFF | 4.36 | 4.03 | 4.01 | 4.11 | 4.56 | 4.75 |
| | ON + OFF | 46.33 | 38.94 | 35.91 | 34.35 | 37.31 | 44.96 |
| 3.155 μm | Voltages | 2.60 | 2.80 | 3.04 | 3.40 | 3.96 | 5.04 |
| | ON | 45.89 | 38.57 | 30.68 | 27.36 | 27.91 | 26.59 |
| | OFF | 4.63 | 4.63 | 4.76 | 4.89 | 5.11 | 5.23 |
| | ON + OFF | 50.52 | 43.20 | 35.43 | 32.25 | 33.02 | 31.82 |
| 3.576 μm | Voltages | 2.60 | 2.76 | 3.00 | 3.40 | 3.90 | 5.04 |
| | ON | 56.83 | 45.25 | 37.14 | 28.63 | 26.74 | 16.63 |
| | OFF | 5.56 | 5.45 | 5.83 | 5.80 | 6.32 | 6.95 |
| | ON + OFF | 62.39 | 50.71 | 42.97 | 34.43 | 33.06 | 23.58 |
| 3.695 μm | Voltages | 2.60 | 2.80 | 3.04 | 3.36 | 3.84 | 5.08 |
| | ON | 58.95 | 48.25 | 37.51 | 28.70 | 25.63 | 15.32 |
| | OFF | 6.35 | 5.90 | 5.89 | 6.53 | 6.77 | 7.35 |
| | ON + OFF | 65.30 | 54.15 | 43.40 | 35.22 | 32.40 | 22.68 |
| 3.923 μm | Voltages | 2.52 | 2.72 | 2.96 | 3.28 | 3.86 | 5.00 |
| | ON | 66.62 | 52.60 | 41.21 | 35.90 | 28.45 | 16.32 |
| | OFF | 6.32 | 6.12 | 6.27 | 6.96 | 7.35 | 8.00 |
| | ON + OFF | 72.94 | 58.72 | 47.48 | 42.86 | 35.80 | 24.33 |

FIG. 4 shows curves corresponding to Table 1.

As shown in FIG. 4, the minimum response times for respective cell gaps are shown at the different specific voltages, and the response times increase as the applied voltages become larger or smaller than the specific voltages. The voltage is referred to a potential difference between the pixel electrode and the reference electrode.

The minimum response times for respective cell gaps are shown in Table 3.

TABLE 3

| | Voltage [V] | Electric Field [V/μm] | |
|---|---|---|---|
| | for Minimum Response | for Minimum | Response |
| d [μm] | Time | Response Time | Time [ms] |
| 2.850 | 3.77 | 1.32 | 34.48 |
| 3.155 | 4.27 | 1.35 | 28.65 |
| 3.576 | 4.70 | 1.31 | 23.61 |
| 3.695 | 4.65 | 1.26 | 21.67 |
| 3.923 | 4.74 | 1.21 | 24.72 |

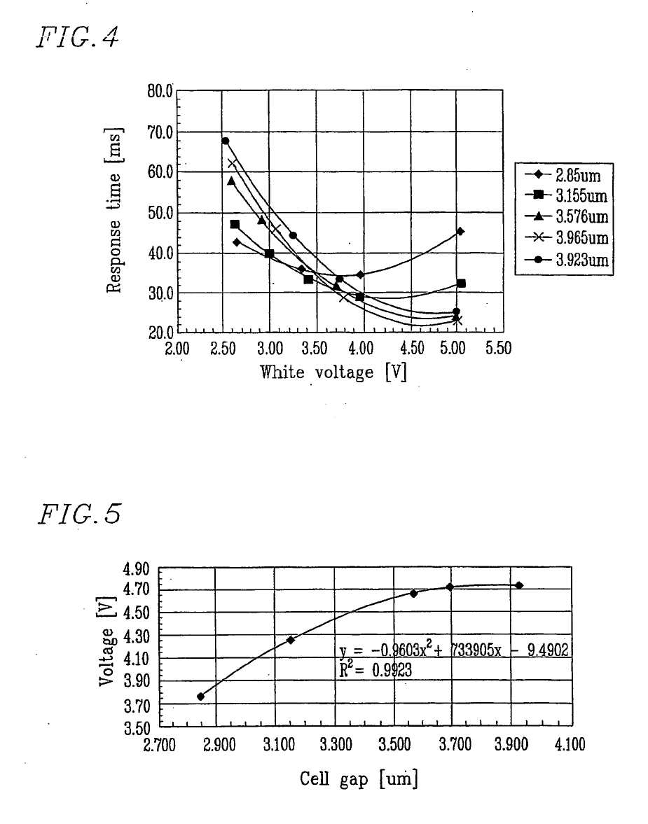

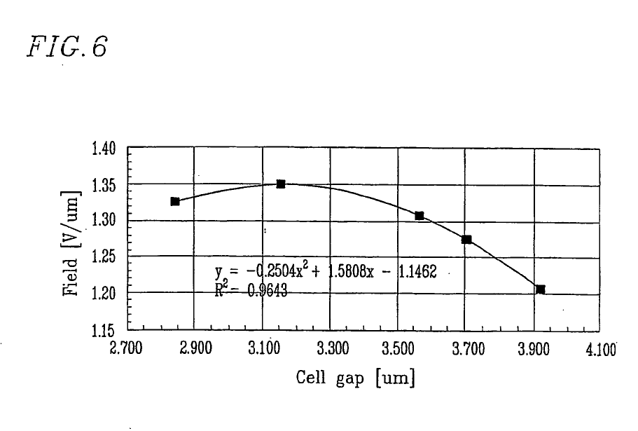

FIG. 5 shows a curve of the voltages giving the minimum response time as function of cell gap described in Table 3. In addition, FIG. 6 shows a curve of the electric field giving the minimum response time as function of cell gap described in Table 3.

As can seen above, when the cell gap d, which is the thickness of the liquid crystal layer, is in a range of 3.4-4.0 μm and the strength of the electric field is in a range of 1.17-1.33 V/μm, as shown in FIG. 6, the response time becomes equal to or lower than 25 ms, which is the standard response time of LCD products displaying moving pictures.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. Especially, the arrangement of the apertures formed on the pixel electrodes and the reference electrodes may have a variety of modifications.

As described above, the adjustment the cell gap and the applied electric field can keep the response time of an LCD to be lower than a predetermined value.

1. A liquid crystal display comprising:
a first insulating substrate;
a pixel electrode formed on the first substrate and having a first aperture pattern;
a thin film transistor formed on the first substrate and switching voltages applied to the pixel electrode;
a second insulating substrate opposite to the first substrate;
a reference electrode formed on the second substrate and having a second aperture pattern to partition the pixel electrode into a plurality of subareas together with the first aperture pattern; and
a liquid crystal layer interposed between the first substrate and the second substrate and having thickness in a range of 3.4-4.0 μm.

2. The liquid crystal display of claim 1, wherein liquid crystal molecules contained in the liquid crystal layer are aligned substantially perpendicular to the first substrate and the second substrate in absence of electric field.

3. The liquid crystal display of claim 1, wherein strength of electric field applied to liquid crystal molecules contained in the liquid crystal layer is in a range of 1.17 V/μm-1.33 V/μm.
